(19) United States
(12) Patent Application Publication
(10) Pub. No.: US 2005/0050150 A1
(43) Pub. Date: Mar. 3, 2005

(54) Filter, system and method for filtering an electronic mail message

(76) Inventor: Sam Dinkin, Austin, TX (US)

Correspondence Address: MCGINN & GIBB, PLLC, 8321 OLD COURTHOUSE ROAD, SUITE 200, VIENNA, VA, 22182-3817, US

(21) Appl. No.: 10/650,971

(22) Filed: Aug. 29, 2003

(51) Int. Cl. G06F 15/16

(52) U.S. Cl. 709/207

(57) ABSTRACT

A filter (system and method) for filtering electronic mail messages includes a recognition (e.g., optical and/or aural recognition) device which analyzes a content of an electronic mail message, and categorizes the electronic mail message based upon a result of the analysis (e.g., optical and/or aural analysis).

### BACKGROUND OF THE INVENTION

1. Field of the Invention

The present invention relates to a filter, system and method for filtering electronic mail (e.g., e-mail) messages, and in particular, a filter, system and method for filtering e-mail messages which uses at least one of optical recognition (OR) and aural recognition (AR).

2. Description of the Related Art

Generally, the term “spam” has come to refer to posting electronic mail messages to news groups or mailing to addresses on an address list the same message an unacceptably large number (generally, 20-25) of times. As used herein, the term “spam” or “junk mail” refers to the sending of unsolicited electronic messages (or “e-mail”) to a large number of users on the Internet. This includes e-mail advertisements, sometimes referred to as Unsolicited Commercial E-mail (UCE), as well as non-commercial bulk e-mail that advocates some political or social position. A “spammer” is a person or organization that generates the junk mail.

The principal objection to junk mail is that it is theft of an organization's resources, such as time spent by employees to open each message, classify it (legitimate vs. junk), and delete the message. Time is also spent by employees following up on advertising content while on the job. In addition, there is an increased security risk from visiting web sites advertised in e-mail messages.

Employees may also be deceived into acting improperly, such as to release confidential information, due to a forged message. Still yet, there is a loss of the network administrator's time to deal with spam and forged messages, as well as the use of network bandwidth, disk space, and system memory required to store the message.

Finally, in the process of deleting junk mail, users may inadvertently discard or overlook other important messages. Another objection to junk mail is that it is frequently used to advertise objectionable, fraudulent, or dangerous content, such as pornography, illegal pyramid schemes or to propagate financial scams.

Spam can also be a serious security problem. For instance, the Melissa worm and ExploreZip.worm were spread almost exclusively via e-mail attachments. Such viruses are usually dangerous only if the user opens the attachment that contains the malicious code, but many users open such attachments.

E-mail may also be used to download or activate dangerous code, such as Java applets, Javascript, and ActiveX controls. E-mail programs that support Hypertext Markup Language (HTML) can download malicious Java applets or scripts that execute with the mail user's privileges and permissions. E-mail has also been used to activate certain powerful ActiveX controls that were distributed with certain operating systems and browsers. In this case, the code is already on the user's system, but is invoked in a way that is dangerous. For instance, this existing code can be invoked by an e-mail message to install a computer virus, turn off security checking, or to read, modify, or delete any information on the user's disk drive.

Both spammers, and those who produce malicious code, typically attempt to hide their identities when they distribute mail or code. Instead of mailing directly from an easily-traced account at a major Internet provider, they may, for instance, send their mail from a spam-friendly network, using forged headers, and relay the message through intermediate hosts. Consequently, the same mechanisms that can be used to block spam can also be used to provide a layer of protection for keeping malicious code out of an organization's internal network.

Simple Mail Transfer Protocol (SMTP) is the predominant e-mail protocol used on the Internet. It is a Transmission Control Protocol/Internet Protocol (TCP/IP) communication protocol that defines the message formats used for transfer of mail from one Message Transfer Agent (MTA) via the Internet to another MTA.

As shown in FIG. 1, Internet mail operates at two distinct levels: the User Agent (UA) and the MTA. User Agent programs provide a human interface to the mail system and are concerned with sending, reading, editing, and saving e-mail messages. Message Transfer Agents handle the details of sending e-mail across the Internet.

According to SMTP, an e-mail message is typically sent in the following manner. A user 1040 (located at a personal computer or a terminal device) runs a UA program 1041 to create an e-mail message. When the User Agent completes processing of the message, it places the message text and control information in a queue 1042 of outgoing messages. This queue is typically implemented as a collection of files accessible to the MTA. In some instances, the message may be created on a personal computer and transferred to the queue using methods such as the Post Office Protocol (POP) or Interactive Mail Access Protocol (IMAP).

The sending network will have one or more hosts that run a MTA 1043, such as Unix sendmail by Sendmail, Inc. of California or Microsoft Exchange. By convention, it establishes a Transmission Control Protocol (TCP) connection to the reserved SMTP port (TCP 25) on the destination host and uses the Simple Mail Transfer Protocol (SMTP) 1044 to transfer the message across the Internet.

The SMTP session between the sending and receiving MTAs results in the message being transferred from a queue 1042 on the sending host to a queue 1046 on the receiving host. When the message transfer is completed, the receiving MTA 1045 closes the TCP connection used by SMTP, the sending host 1043 removes the message from its mail queue, and the recipient 1048 can use his configured User Agent program 1047 to read the message in the mail queue 1046.

FIG. 2 is a graphical representation of an example of the SMTP messages sent across the Internet. In this example, sender@remote.dom sends a message to user@escom.com (The top-level domain name “dom” does not actually exist, and is used for illustrative purposes only to avoid referring to an example domain).

The sending host's Message Transfer Agent 1001 sends an e-mail message to the receiving host 1002. At step 1010, the sending MTA opens a TCP connection to the receiving host's reserved SMTP port. This is shown as a dashed line with an italics description to differentiate it from the subsequent protocol messages. This typically involves making calls to the Domain Name System (DNS) to get the IP address of the destination host or the IP address from a Mail Exchange (MX) record for the domain. For example, the domain escom.com has a single MX record that lists the IP address 192.135.140.3. Other networks, particularly large Internet Service Providers (ISPs), might have multiple MX records that define a prioritized list of IP addresses to be used to send e-mail to that domain.

The sending MTA typically establishes the connection by: (1) making a socket system call to acquire a socket (a structure used to manage network communications); (2) filling in the socket structure with the destination IP address (e.g., 192.135.140.3); (3) defining the protocol family (Internet) and destination port number (by convention, the MTAs use the reserved TCP port 25); and, (4) making a connect system call to open a TCP connection to the remote MTA and returning a descriptor for the communications channel.

The process of opening a TCP connection causes the receiving host's operating system (or networking software) to associate the TCP connection with a process that is listening on the destination TCP port. The TCP connection is a bi-directional pipe between the sending MTA 1001 on the sending host and the receiving MTA 1002 on the receiving host. SMTP is line-oriented, which means that all protocol messages, responses, and message data are transferred as a sequence of ASCII characters ending with a line feed (newline) character.

In step 1011, the receiving MTA sends a service greeting message when it is ready to proceed. The greeting message typically gives the host name, MTA program and version number, date/time/timezone, and perhaps additional information as deemed by the host administrator. The greeting lines begin with the three-character numeric code “220”. By convention, the last/only line begins with the four-character sequence “220” and any preceding lines begin with “220-”.

When the greeting message is received, the sending MTA may optionally send a HELO message, step 1012, that lists its host name. Some mail servers require the sending host to issue this message, and others do not. If the client (sending) MTA issues the HELO message, then the server (receiving MTA) issues a HELO response, step 1013, that lists its name. For Extended SMTP (ESMTP), the sending host sends an EHLO message that performs essentially the same function as the HELO message. In this case, the receiving host generates a multi-line reply listing the extended SMTP commands that it supports.

At step 1014, the sending MTA sends a MAIL From: message to identify the e-mail address of the sender of the message, e.g., sender@remote.dom. By convention, the Internet address is formed by concatenating the sending user's account name, the “@” sign, and the domain name of the sending host. The resulting address is typically enclosed in angle-brackets, however, this is not usually required by the receiving mail server. It is noted that spammers can easily forge the MAIL address.

At step 1015, the receiving mail server sends either a “250” response if it accepts the MAIL message or some other value such as “550”, if the message is not accepted. The receiving mail server may reject the address for syntactical reasons (e.g., no “@” sign) or because of the identity of the sender.

At step 1016, the sending MTA sends a RCPT To: message to identify the address of an intended recipient of the message, e.g., user@escom.com. Again, this is a standard Internet address, enclosed in angle-brackets.

At step 1017, the receiving server replies with a “250” status message if it accepts the address, and some other value if the MAIL message is not accepted. For example, sendmail 8.9.3 issues a 550 message if the specified recipient address is not listed in the password file or alias list. The sending MTA may send multiple RCPT messages (step 1016), usually one for each recipient at the destination domain. The receiving server issues a separate “250” or “550” response as shown in step 1017 for each recipient.

At step 1018, the sending mail server sends a DATA message when it has identified all of the recipients. The server sends a response (nominally, “354”, as shown in step 1019) telling the sending server to begin sending the message one line at a time, followed by a single period when the message is complete.

When the sending MTA receives this reply, it sends the text of the e-mail message one line at a time as shown in step 1020. Note that it does not wait for a response after each line during this phase of the protocol. The message includes the SMTP message header, the body of the message, and any attachments (perhaps encoded) if supported by the sending User Agent program.

When the message transfer has been completed, the sending MTA writes a single period (“.”) on a line by itself (step 1021) to inform the destination server of the end of the message. The receiving MTA typically responds (step 1022) with a “250” message if the message was received and saved to disk without errors. The sending MTA then sends a “quit” (step 1023) and the receiving MTA responds with a “221” message as shown in step 1024 and closes the connection.

FIG. 3 shows the same information, using a text representation of the SMTP messages between the sending MTA (remote.dom) and receiving MTA (escom.com). The first character of each line indicates the direction of the protocol message. The “>” character indicates the direction of the protocol message sent by the sending MTA, and “<” indicates the direction of a message sent by the receiving MTA. These characters do not form a part of the message being transmitted.

The e-mail message header is transferred at the beginning of the message and extends to the first blank line. It includes Received: lines added by each MTA that received the message, the message timestamp, message ID, To and From addresses, and the Subject of the message. The message header is followed by the body of the message (in this case, a single line of text), the terminating period, and the final handshaking at the end of the message. Here, the term “message” alone refers to the overall e-mail message as well as the multiple protocol messages (e.g., HELO, MAIL and RCPT) that are used by SMTP.

Conventional methods used to block junk mail include blacklisting (centralized and local) in which a filter rejects all sender addresses that are included in a blacklist, blocking mail from nonexistent domains, and whitelisting in which a filter rejects all sender addresses that are not included in a local whitelist.

Other conventional methods use Bcc filtering to reject e-mail from unknown hosts that do not list the recipient's e-mail address in the header of the message. Another method involves rejecting junk mail located in the user's mailbox without downloading the mail to the user's mail program (UA). Filtering of client protocols such as POP provides relief to individual users, but still allows junk mail to be stored on the SMTP server. Finally, other conventional methods use secure electronic mail, in which public key cryptography is used to provide security services such as secrecy (confidentiality), integrity (ability to detect modification), authentication, and non-repudiation.

However, conventional filtering systems and methods do not provide an adequate solution to spam. All of the conventional methods are designed to drive the cost of spam to $0.01/e-mail. However, this will likely be ineffective at stopping spam.

Further, the strategy of most conventional e-mail filtering software is to use keywords and other text filtering. Thus, offensive text and/or other information can be conveyed in graphics. Therefore, spammers can move offshore and embed undesirable information in graphical images which cannot be filtered. Sometimes, the undesirable information such as pornography can be conveyed directly as a graphical image. Existing filtering techniques do not address these problems.

### SUMMARY OF THE INVENTION

In view of the foregoing and other exemplary problems, disadvantages, and drawbacks of the aforementioned assemblies and methods, it is a purpose of the exemplary aspects of the present invention to provide a system and method for filtering electronic mail messages that efficiently and effectively filters electronic mail messages.

An exemplary aspect of the present invention includes a filter for filtering electronic mail messages. The filter includes an recognition (e.g., optical and/or aural recognition) device (e.g., optical recognition module) which analyzes (e.g., optically and/or aurally analyzes) at least one of a visual content and an aural (e.g., audio) content (e.g., content of the body and/or an attachment) of an electronic mail message, and categorizes the electronic mail message based upon the results of the analysis. For example, the filter may open an electronic mail message (e.g., attachment to a message), and optically (e.g., visually) or aurally (e.g., aurally) analyze the message before the message is opened by a user (e.g., an intended recipient of the message).

The content may include an image or an audio portion. Further, the optical recognition device may include an optical image recognition device which indexes, recognizes, and describes the image according to at least one visual feature in the image. Further, the image may include one of a photograph, design, and illustration. In addition, the optical recognition device may analyze (e.g., visually analyze) the content by segmenting the image into a plurality of segments.

Further, the optical recognition device may assign an identifier to at least one segment in the plurality of segments. For example, the identifier may include at least one of a color, texture, shape, spatial configuration, image quality, image size, image brightness, contrast, distortion, object translation, object rotation and scale, and any combination thereof.

The filter may also include at least one feature (e.g., visual and/or audio feature) database (e.g., a legitimizing feature and/or de-legitimizing feature database). Thus, the optical recognition device may compare the identifier with data (e.g., features) in the feature database.

Further, features stored in the feature database may be weighted according to at least one of a legitimizing degree and de-legitimizing degree. In addition, the features may be compared with the identifiers in the order of degree (e.g., legitimizing degree and/or de-legitimizing degree).

For example, the data stored in the feature database may include de-legitimizing features such as a de-legitimizing word, de-legitimizing image, de-legitimizing grammar, de-legitimizing alphanumeric character, and de-legitimizing punctuation mark. The data may also include legitimizing features such as a legitimizing word, legitimizing image, legitimizing grammar, legitimizing alphanumeric character, and legitimizing punctuation mark.

Further, the recognition (e.g., optical and/or aural recognition) device may categorize the electronic mail message into one of at least two categories (e.g., legitimate and illegitimate). In addition, the recognition device may include at least one of an optical character recognition device and an optical image recognition device. Further, the recognition device may analyze the content and categorize the electronic mail message in substantially real time.

Further, the recognition device may include a display screen which displays the content. For example, this would allow the electronic mail message to be analyzed by a human being who may view the content on the display screen, and categorize the e-mail message based on his visual analysis.

In addition, the recognition device may include a trainable (e.g., self-learning) recognition device. Further, the recognition device may analyze the content according to a predetermined recognition (e.g., optical and/or aural recognition) algorithm.

Another exemplary aspect of the present invention includes a system for filtering electronic mail messages. The system includes a network having a plurality of user terminals, and at least one filter for filtering electronic mail messages sent between terminals in the plurality of terminals, the at least one filter including an optical recognition device which analyzes a content of an electronic mail message, and categorizes the electronic mail message based upon the content. For example, the system may include a plurality of filters (e.g., at least one centrally-located filter and at least one distributed filter).

The inventive system may also include a alternative processing device which routes the electronic mail message which has been categorized. Thus, for example, if the electronic mail message is categorized as legitimate, the system may forward the electronic mail message to an intended receiver of the electronic mail message, but if the electronic mail message is categorized as illegitimate, the alternative processing device may alternatively route the e-mail message (e.g., routes the electronic mail message back to a sender of the electronic mail message or according to another route selected by the user).

Another exemplary aspect of the present invention includes an inventive method of filtering electronic mail messages. The inventive method includes analyzing (e.g., optically and/or aurally) a content of an electronic mail message, and categorizing the electronic mail message based upon a result of the analysis.

The present invention also includes a programmable storage medium tangibly embodying a program of machine-readable instructions executable by a digital processing apparatus to perform the inventive method.

With its unique and novel features, the present invention provides a filter, system and method for filtering electronic mail messages which efficiently and effectively filters electronic mail messages (e.g., messages including images or an audio portion).

### BRIEF DESCRIPTION OF THE DRAWINGS

The foregoing and other exemplary aspects and advantages will be better understood from the following detailed description of the exemplary embodiments of the invention with reference to the drawings, in which:

FIG. 1 illustrates a simple mail transfer protocol (SMTP) architecture 1000 of a conventional electronic mail system;

FIG. 2 illustrates an example of an SMTP message transfer in an conventional electronic mail system;

FIG. 3 illustrates a detailed example of an SMTP message transfer in an conventional electronic mail system;

FIG. 4A illustrates an exemplary method 490 of filtering electronic mail messages according to an exemplary aspect of the present invention

FIG. 4B illustrates a filter 400 for filtering electronic mail messages, in accordance with an exemplary aspect of the present invention;

FIG. 5 illustrates a system 500 for filtering electronic mail messages, in accordance with an exemplary aspect of the present invention;

FIG. 6 illustrates a display screen 600 which may be included in a system for filtering electronic mail messages, in accordance with an exemplary aspect of the present invention;

FIG. 7 illustrates a method 700 of filtering electronic mail messages, in accordance with an exemplary aspect of the present invention;

FIG. 8 illustrates a typical hardware configuration which may be used for implementing the inventive system and method for filtering electronic mail messages, in accordance with an exemplary aspect of the present invention; and

FIG. 9 illustrates a programmable storage medium which may be used to store instructions for performing a method of filtering electronic mail messages, in accordance with an exemplary aspect of the present invention.

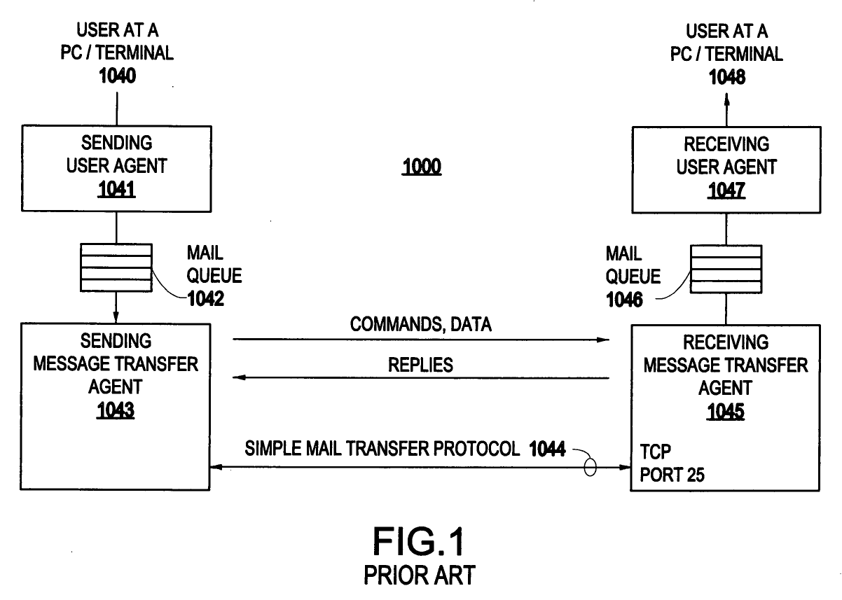

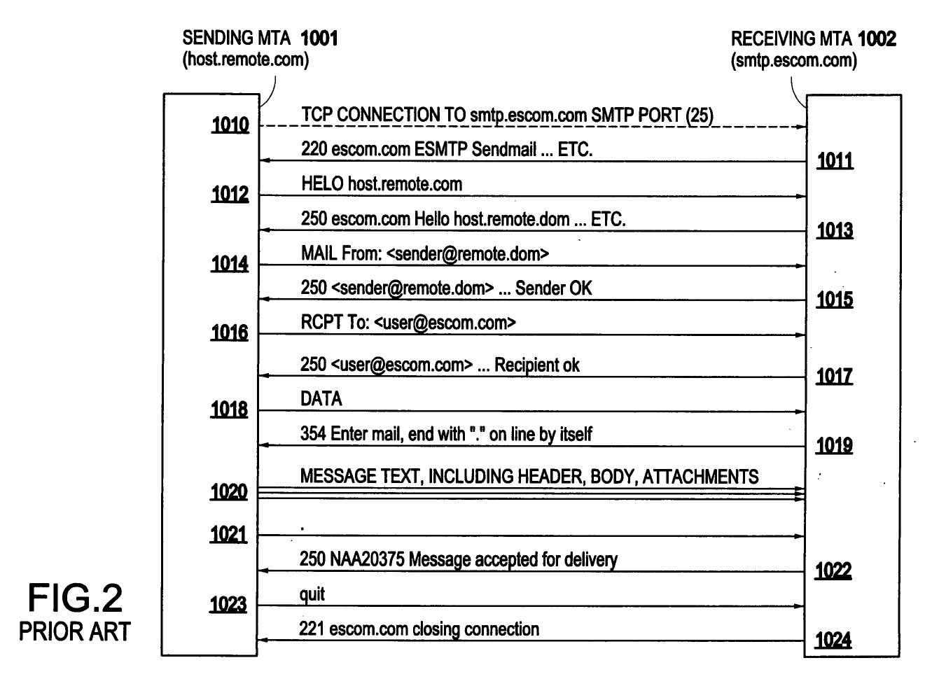

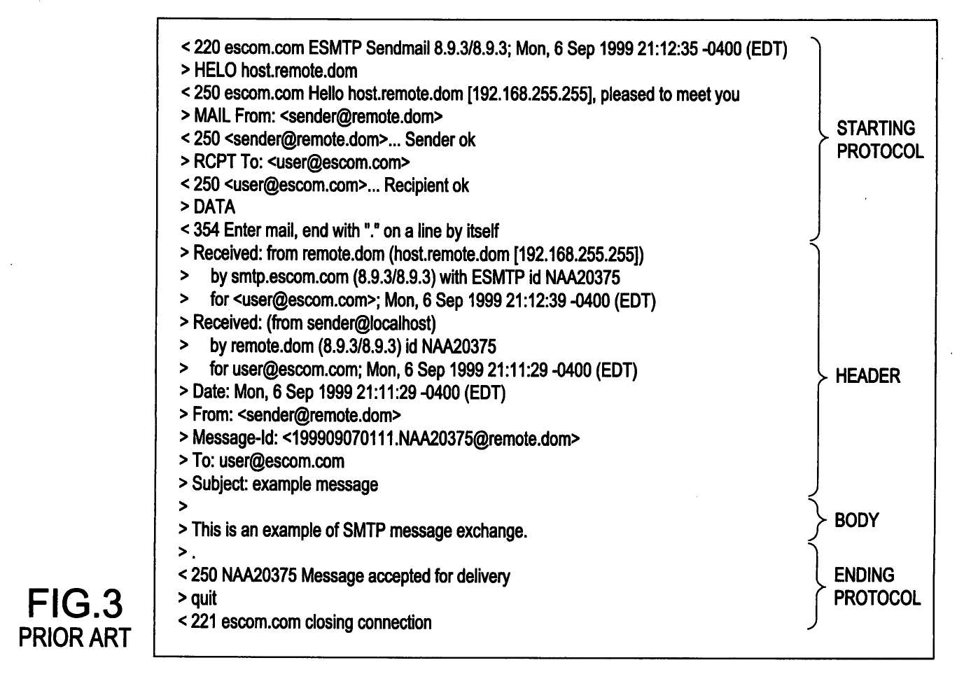

### DETAILED DESCRIPTION OF THE EXEMPLARY EMBODIMENTS OF THE INVENTION

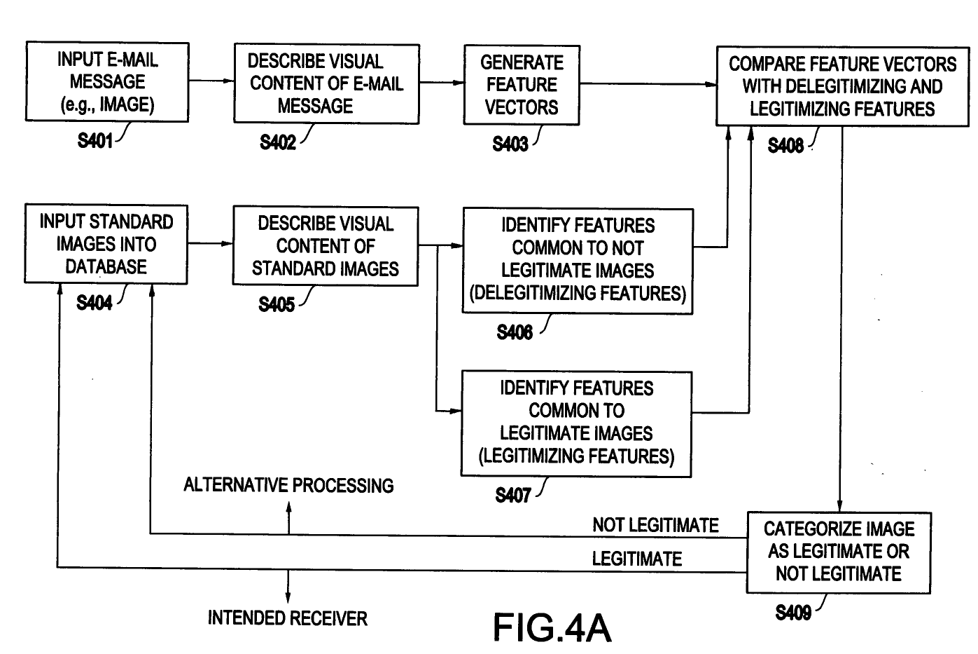

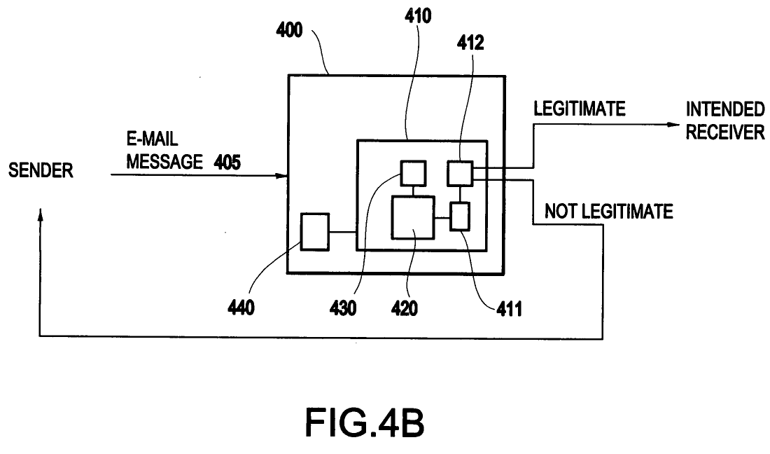

Referring now to the drawings, FIG. 4A illustrates an exemplary method 490 of filtering electronic mail messages according to an exemplary aspect of the present invention.

Conventional content-based image retrieval systems use the visual contents of an image such as color, shape, texture, and spatial layout to represent and index the image. An example, of such a system is described by Long, et al, Multimedia Information Retrieval and Management-Technological Fundamentals and Applications, Chapter 1: Fundamentals of Content-based, Image Retrieval, Springer, 2002, which is incorporated herein by reference.

However, unlike such conventional image retrieval systems, the present invention filters electronic mail messages by analyzing a content of the electronic mail message, and categorizing the electronic mail message based upon a result of the optical analysis. For example, as shown in FIG. 4A, this exemplary method 490 of the present invention may include inputting an e-mail message (S401) (e.g., inputting an image of the electronic mail message, or an image included in the e-mail message), describing a visual content of the e-mail message (e.g., image) (S403), and generating feature vectors for the e-mail (e.g., image) (S404).

The method 490 may also include inputting a standard image (e.g., a plurality of images) into a database (S404). These standard images may be identified, for example, as legitimate or not legitimate. The method 490 may further include describing a visual content of the standard images (S405), and identifying features in the standard images (e.g., identifying features common to illegitimate images (e.g., delegitimizing features) (S406) and identifying features common to legitimate images (e.g., legitimizing features) (S407)). The standard images may be stored in a standard image database, and/or the features may be stored, for example, in one or more feature databases.

The method 490 may further include comparing the feature vectors generated at step (S403), with the legitimizing and delegitimizing features identified in steps (S407) and (S406), respectively (e.g., an optical analysis). The results of this comparison (e.g., analysis) may be used to categorize (S409) the message (e.g., image) as legitimate or not legitimate. A message categorized as legitimate may be forwarded to an intended receiver, and a message categorized as not legitimate may be alternatively processed (S410) (e.g., returned to sender, etc.).

Further, a message (e.g., image) categorized as not legitimate may be fed back and stored in the standard image database, as a way of updating the standard image database. In this manner, the invention may update (e.g, periodically or continuously) the features which are identified as common to illegitimate images. Similarly, a message categorized as legitimate may fed back in order to update the features which are identified as common to legitimate images.

For example, the invention may keep track of the number of times a particular feature is found in messages (e.g., images) which have been categorized as legitimate. After the feature is found a predetermined number of times (e.g., a threshold amount) in legitimate images, the feature may be added to the list of legitimizing features.

Similarly, the invention may keep track of the number of times a particular feature is found in messages (e.g., images) which have been categorized as not legitimate. After the feature is found a predetermined number of times (e.g., a threshold amount) in not legitimate images, the feature may be added to the list of delegitimizing features.

Further, it will be understood by one of ordinary skill in the art that the inventive method 490 may be modified to use an aural analysis to filter an electronic message in addition to or instead of an optical analysis.

Another exemplary aspect of the present invention is illustrated in FIG. 4B which illustrates a filter 400 for filtering electronic mail messages. The inventive filter 400 includes an optical recognition device (e.g., module) 410 which analyzes (e.g., optically analyzes) a content of an electronic mail (e.g., e-mail) message, and categorizes the electronic mail message based upon a result of the optical analysis.

For example, the optical recognition module 410 may include an optical analyzer 411 which analyzes (e.g., optically analyzes) a content of an electronic mail message (e.g., segments the image and compares the segments to stored data), and a categorizer 412 connected to the analyzer 411 which categorizes the electronic mail message based upon a result of the optical analysis.

With the present invention, an e-mail message (e.g., a message including an image or having an image attached thereto) 405 may be efficiently and effectively filtered using the inventive filter 400 (e.g., optical filter) which includes the optical recognition device 410. The filter 400 may analyze the content (e.g., recognized data) to determine if the intended receiver would likely not want to receive the e-mail.

If so, the e-mail may be filtered out and alternatively processed. For example, an e-mail message which is alternatively processed may be canceled or returned to the sender. Further, the content (e.g., image) of the alternatively processed e-mail may be displayed so that a person (e.g., human being) may analyze the content to assess whether it contains information which the receiver would likely not want to receive.

If, on the other hand, the filter 400 determines that the intended receiver would want to receive the e-mail, the e-mail may be sent to the recipient (e.g., as with a routine processing).

The inventive filter 400 may be especially effective at filtering content which is in a format (e.g., non-text format) which is not easily filterable using a text-based filter. For example, the filter 400 may be used to filter content which includes not only images (e.g., a photographic image of a person) but also characters, words, phrases, etc. which are included in an image or in a non-text format (e.g., Portable Document Format (PDF)).

More specifically, the optical recognition device may include an optical character recognition device, an optical image recognition device, or an optical recognition device which is capable of recognizing and filtering characters (e.g., alphanumeric characters) and images. For example, the filter 400 may be used to filter an e-mail message including alphanumeric characters embedded in an image, or a signature in a PDF file, etc. It should be noted that for purposes of the present application, the term “image” should be construed to include any content in a non-text formation (e.g., an illustration, photographic image, optically scanned bitmap of printed matter or written text characters, etc.).

Generally, the optical recognition device 410 may be used to translate an image into character codes, such as ASCII. More specifically, the OR device may turn visual content (e.g., images and characters) in an electronic mail message into data (e.g., a data file) that can be analyzed and categorized (e.g., by a processor such as in a personal computer).

Thus, for example, the filter 400 may display an e-mail message, and use the optical recognition device 410 to convert the displayed image into ASCII code which may be analyzed. Therefore, the optical recognition device 410 may open the electronic mail message and physically display the image, so that an optical analysis may be performed on the displayed message (e.g., image).

Alternatively, the optical recognition device 410 may perform an analysis without “opening” the e-mail message and without physically displaying the message (e.g., image). In this case, the optical recognition device 410 may analyze the display data which is used to form the image on a display. In this case, for example, the optical analysis of an image may be performed on a pixel by pixel basis. In this case, the content of a pixel (e.g., display data for the pixel) may be individually analyzed and compared with data (e.g., display data) stored in the database 410. Further, the pixels may be grouped together according in a predetermined manner, so that the image is analyzed by comparing the groups of pixels (e.g., groups of display data) to data stored in the database 420.

In one exemplary embodiment, the optical recognition device may include an optical image recognition device (e.g., an optical image recognition engine). In this exemplary embodiment, the optical image recognition device may provide a real-time solution that allows computers to see, understand and translate visual content.

For example, the optical image recognition device may include an image analysis engine that indexes, recognizes, and/or describes an image according to at least one visual feature (e.g., a single feature or a plurality of features) of an image included in (e.g., attached to) an electronic mail message. The recognition device may, for example, analyze a photograph, design, illustration or other visual (e.g., containing other than alphanumeric text characters), digital element. Further, the recognition device may produce a description of the content.

The optical image recognition device may describe the visual content of the electronic mail message in a standard explicit manner. For example, the results from the optical image recognition device can be an absolute content description. For example, the device may output a message to the user such as “the image depicts two persons and an automobile”. However, it is important to note that such an output is not necessary in the claimed invention. That is, the claimed invention may simply analyze and categorize the image (e.g., as legitimate or not legitimate) without necessarily identifying what is depicted in the image.

The optical image recognition device may perform optical image analysis and optical image indexing according to a predetermined optical recognition algorithm. For example, the optical image recognition device may perform an image analysis in which the image may be segmented. In this case, the image is broken down into relevant segments (e.g., visually-stable segments) (e.g., using a nonparametric, multiscale approach).

The optical image recognition device may also perform an image indexing. Further, the optical image recognition device may break down a complex image into segments (e.g., visually-relevant segments), which may be referred to as “image segmentation”.

The optical image recognition device may assign a unique identifier (e.g., signature) to segments (e.g., at least one segment) in the segmented image. The identifier may include, for example, an optimized combination of unique visual features such as color, texture, shape, and spatial configuration. The identifier may also include extended invariance properties specific to image quality, image size, image brightness, contrast, distortion, object translation, object rotation and scale.

The optical image recognition device may, therefore, represent the image using a compact numerical vector which efficiently encodes details of its content. In its dual representation, the image may be viewed as a point in a high-dimensional feature space. The feature space may be extensively tested and optimized in order to maximize the discriminance of the description process.

In addition, the optical recognition device 410 may include a feature database 420. For example, the feature database 420 may include a de-legitimizing feature database. In this case, the data stored in the feature database may include de-legitimizing features such a de-legitimizing words, de-legitimizing images, de-legitimizing grammar, de-legitimizing alphanumeric characters, and/or de-legitimizing punctuation marks.

The optical recognition device 410 may also include a comparator 430 (e.g., connected to the feature database 420 and optical analyzer 411) which may compare the content in the electronic mail message with one or more of the features in the feature database 420.

Similarly, the database 420 may include a legitimizing feature database. In this case, the data may include legitimizing features such as legitimizing words, legitimizing images, legitimizing grammar, legitimizing alphanumeric characters, and/or legitimizing punctuation marks. The comparator 430 may compare the content with the legitimizing features in the legitimizing feature database (e.g., and identify which of legitimizing features are absent in the content). It should be noted that the lists of legitimizing and de-legitimizing features included herein are merely intended to be illustrative and should in no way be considered as limiting the present invention.

Further, the optical image recognition device (e.g., comparator 430) may compare the identifier (e.g., signature) with data in a feature database (e.g., legitimizing feature database and/or de-legitimizing feature database) and use the results of the comparison to determine whether the image should be categorized as legitimate or not legitimate. The feature database 420 may also either be an internal database or an external database to which the comparator 430 may be linked.

For example, assume that a sender forwards an e-mail message to a recipient, and that attached to the e-mail message is a photograph (e.g., a JPEG file). Further, assume that the filter 400 is used to filter the message, and performs an optical analysis of the message. Further assume that the filter 400 detects 3 de-legitimizing features (e.g., a de-legitimizing image quality, de-legitimizing image brightness, and a de-legitimizing object translation) pertaining to the photograph (e.g., the JPEG) file.

Further, the database 420 and comparator 430 may enable absolute content description, and/or enable relative content description (e.g., describing the image as relative to some standard, such as a standard image). However, as noted above these functions are not necessary for the present invention.

Further, a semantic description may be inferred from the identifier using a pattern recognition algorithm. For example, the present invention (e.g., the optical recognition device) may use a state-of-the-art pattern recognition algorithm, such as Neural Networks, Radial Basis Functions, Bayesian Estimation, and Support Vector Machines to infer a semantic description from the identifier.

For example, in an exemplary aspect, the pattern recognition procedure may be designed so that a pattern recognition machine may recognize patterns (e.g., statistically recognize patterns) like a human being. Further, patterns may be stored in the database 420, and patterns (e.g., legitimatizing and/or de-legitimizing patterns) which are detected (e.g., identified) in a message (e.g., image) by a pattern matching algorithm may be compared to the stored patterns in the database 420.

For example, certain patterns (e.g., group of patterns) which are detected in an image may be considered as legitimizing and/or de-legitimizing. For example, patterns pertaining to image quality, image size, image brightness, contrast, distortion, object translation, object rotation and scale, may be stored and compared by the present invention in order to categorize the e-mail message (e.g., as legitimate or not legitimate).

With the optical recognition device 410, the filter 400 may outperform conventional filters. Further, the flexibility and learning abilities (e.g., trainability) of the filter 400 may further improve the performance of the filter 400. For example, the filter 400 may learn object profiles, and refine its sense of what an object “looks like”.

This “trainability” (e.g., adaptiveness) of the filter 400 may allow the filter to continuously enrich and update certain features and functions (e.g., the optical recognition algorithm, contents of the feature database, etc.). For example, the filter 400 may be designed to learn from a user action in an interactive context. In short, the learning function may be used to improve the performance of the filter.

For example, the filter may identify which e-mails have been handled in a predetermined manner (e.g., opened) by the recipient and store the characteristics (e.g., keywords, URL, etc.) as “non-spam” so that in the future, e-mails received by the recipient including those characteristics will more likely be classified as non-spam. On the other hand, the characteristics (e.g., keywords, URL, etc.) of e-mails have been handled in another manner (e.g., deleted without opening), will be stored as spam, so that in the future e-mails received by the recipient including those characteristics will more likely be classified spam.

Specifically, the filter 400 may be used to filter an electronic message to remove images which the intended receiver may find objectionable (e.g., lewd or obscene photographs, videos, drawings, etc.) or images that the intended receiver may not be interested in receiving (e.g., unsolicited advertisements). For example, the filter 400 (e.g., the optical recognition device 410) may store de-legitimizing features related to obscene photographs in the feature database. Such features may include, for example, sexually suggestive (e.g., pornographic) photographs.

As noted above, the optical recognition device 410 in the present invention does not necessarily (although it may) analyze the entire content (e.g., image content) of the e-mail message. This is because an object of the optical recognition device 410 is to detect a feature (e.g., plurality of features or combination of features) which would make the intended receiver not want to receive the e-mail message. Therefore, the optical recognition device does not need to describe the entire content of the e-mail message.

Thus, for example, the optical recognition device does not need to analyze the content to the extent that it can describe the content as depicting two people sitting in a bright outdoor setting or three people standing in a dark indoor setting. Instead, the optical recognition device needs only to analyze a sufficient portion (e.g., a sufficient number of segments) of the content to confirm that the e-mail is legitimate or illegitimate, at which point it may categorize the e-mail accordingly. In other words, the optical image recognition device of the present invention may only extract (e.g., detect) sufficient information (e.g., a sufficient amount of legitimizing or de-legitimizing features) in order to categorize the e-mail.

For example, the optical recognition device may use an iterative process to analyze the content one segment (e.g., identifier) at a time, and compare the segment with features in a feature database. This may allow a segment of the content to be individually extracted from the image and compared with features stored in the feature database. Thus, for example, when a sufficiently legitimizing feature or combination of legitimizing features are detected, the e-mail may be categorized as such, so that no more processing needs to be performed. Similarly, when a sufficiently de-legitimizing feature or combination of de-legitimizing features are detected, the e-mail may be categorized as such, so that no more processing needs to be performed.

Further, the de-legitimizing features may be sorted into two categories, absolute and non-absolute. For example, once a content is determined to include (e.g., match) an absolute de-legitimizing feature (e.g., a feature which is common to pornographic photographs) by the optical recognition device, the filter may cease further analysis, and categorize (e.g., automatically categorize) the e-mail message as illegitimate.

Similarly, the filtering may sort legitimizing features into two categories, absolute and non-absolute. For example, once a content is determined to include (e.g., match) an absolute legitimizing feature (e.g., a feature which the filter determines to be related to the receiver's family photograph) by the optical image recognition device, the filter may cease further analysis, and categorize (e.g., automatically categorize) the e-mail message as legitimate.

More specifically, the present invention recognizes that certain features (e.g., features common to a pornographic photograph) in an e-mail message (e.g., an image in an e-mail message or attached to an e-mail message) may be sufficient in and of themselves to cause the e-mail to be categorized (e.g., automatically categorized) as legitimate or not legitimate. This allows the present invention to avoid a large amount of time consuming and costly processing ordinarily performed by conventional image analysis devices.

If, on the other hand, no absolute legitimizing or de-legitimizing features are identified by the optical recognition device (e.g., if only non-absolute features are identified), the filter may weigh the legitimizing features against the de-legitimizing features in order to categorize the e-mail message, allowing the optical recognition device to quickly and efficiently categorize the e-mail, so that the filter can operate in real time (e.g., substantially real time).

Further, the features stored in the feature database may be weighted according to a legitimizing degree or de-legitimizing degree. The invention may compare these features against the identifiers assigned to segments of the image in the order of their degree. For example, the most legitimizing features and most de-legitimizing features may be compared first. Moreover, because the inventive filter is trainable, these weights may be automatically adjusted based on a past history.

Further, the e-mail message may be assigned a total score based on the weights assigned to the features detected in the content (e.g., image content). For example, where the content is analyzed to include de-legitimizing features having weighted scores of 0.90, 0.81, and 0.72, respectively, and legitimizing features having weighted scores of −0.95 and −0.92, these scores may be summed, to obtain a total score (e.g., 0.56) that may be compared to a threshold value to determine whether the e-mail message should be rejected (e.g., considered illegitimate).

Further, the filter 400 may be centrally located, such as in a server in a computer network (e.g., the world wide web, local area network (LAN) or wide area network (WAN)). Alternatively or additionally, the filtering device may be included in an individual terminal (e.g., a personal computer) connected to the network. For example, the filtering device may include software stored on the personal computer of the intended receiver. Thus, when the intended receiver begins to use the mail browsing application on his personal computer, the electronic mail messages may be filtered beforehand, so that any electronic mail message including content categorized by the filtering device as illegitimate would not be listed on the display screen of the mail browser.

Further, the filter 400 may additionally include an additional database(s) 440 which may be used in conjunction with the optical recognition device 410. For example, the optical recognition device (e.g., categorizer 412) may access and receive input from the additional database(s) 440 to categorize the e-mail message. Alternatively, the filter 400 may include a secondary categorizer (not shown) which receives input (e.g., categorizing information) from the optical recognition device 400 (e.g., categorizer 412), and data from the additional database(s) 440 and makes a final determination as to how the e-mail message should be categorized. For example, the secondary categorizer may override the decision of the optical recognition device 410 based on the data contained in the additional database(s) 440.

For example, the additional database 440 may include a “blacklist” of senders (e.g., sender database) from which e-mail is automatically rejected (e.g., without having to analyze the content contained therein). When an e-mail is rejected the system may automatically add the sender address to the blacklist. Likewise, the additional database 440 may include a “whitelist” of senders from which an e-mail is automatically passed through to the intended receiver. The inventive filter 400 may also work in cooperation with and/or supplement the filtering provided by conventional filtering devices.

Further, the inventive filter 400 may be used to filter electronic mail messages in substantially real time. Thus, a user (e.g., the intended receiver of the e-mail messages) should realize little delay caused by the use of the filter 400.

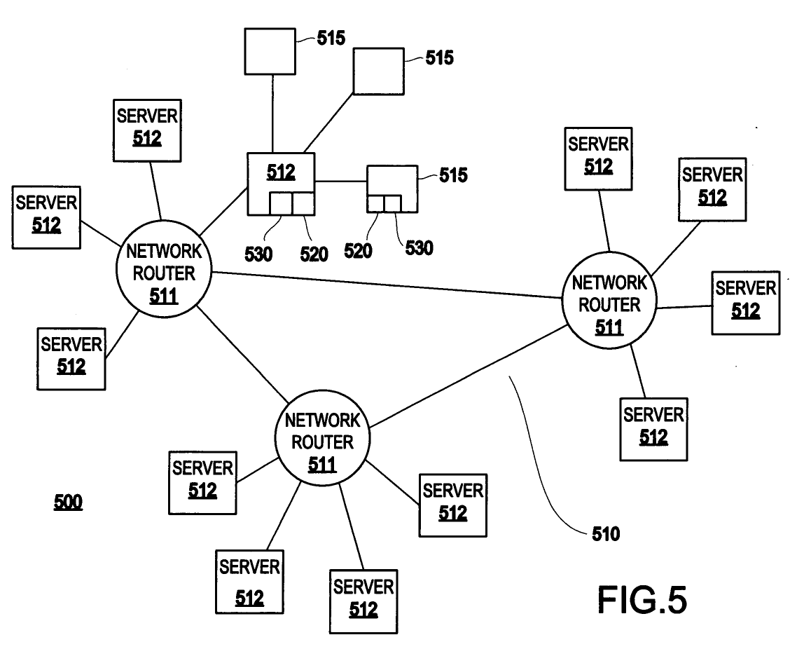

Referring again to the drawings, FIG. 5 illustrates an inventive system 500 for filtering electronic mail messages. The inventive system includes a network 510 (e.g., the Internet) including network routers 511, servers (e.g., SMTP servers) 512, and a plurality of user terminals 515 (e.g., personal computers connected to the network), and at least one filter 520 (e.g., plurality of filters) as described in detail above for filtering electronic mail messages sent between terminals in the plurality of terminals. Further, the at least one filter 520 includes an optical recognition device which analyzes a content of an electronic mail message, and categorizes the electronic mail message based upon the analysis.

For example, the filter 520 may include software installed in the user terminal 515 (e.g., on the hard drive of the user terminal). The software may be used by the user to control the filter 520 through a graphical user interface (e.g., an input device, display device, etc.).

In addition, the inventive system 500 may also include an alternative processing device 530 which may process e-mail (e.g., illegitimate e-mail) which has been categorized such that it is not being forwarded to the intended receiver. For example, the alternative processing device 530 may cancel the e-mail or return the e-mail to the sender with a message.

Further, the alternative processing device 530 may be centrally located in a server (e.g., SMTP server) 512 or in a user terminal 515. For example, if the electronic mail message is categorized as legitimate, the system 500 may forward the electronic mail message to an intended receiver of the electronic mail message. If, on the other hand, the electronic mail message is categorized as illegitimate, the alternative processing device 530 may return the electronic mail message back to the sender.

Further, the system 500 may include a filter 520 which is centrally located (e.g., in a server of a distributed network) and a filter 520 which is located elsewhere (e.g., in a user terminal 515). For example, the filter 520 may include filtering software which is stored in the personal computer of an intended receiver.

Further, the distributed filter 520 located in a user terminal may perform operations similar to those of the centrally-located filter 520 and, therefore, be used as an additional layer of filtering as a form of redundancy. Alternatively, the filters may be designed to operate in a coordinated manner, so as to reduce or eliminate a duplication of the filtering operations. For example, the inventive system 500 may identify certain portions (e.g., images or text) of an electronic mail message to be filtered by the centrally-located filter 520, and certain portions which are to be filtered at the distributed filter 520. As another example, only the centrally-located filter 520 may be operable during a certain time of the day, week, month, etc., and at other times only the distributed filter 520 may be operable. Further, such operations of the filters are fully adjustable by the user from his user terminal using filter control software which may be installed in the user terminal, or remotely installed but accessible via the user terminal.

Further, the present invention allows a user to select from among the plurality of filters which are to be used. For example, the system may include filters 1-8 but the user may only want to use filters 1-5 and 7. Thus, the user may deactivate filters 6 and 8, and/or activate filters 1-5 and 7 from his user terminal.

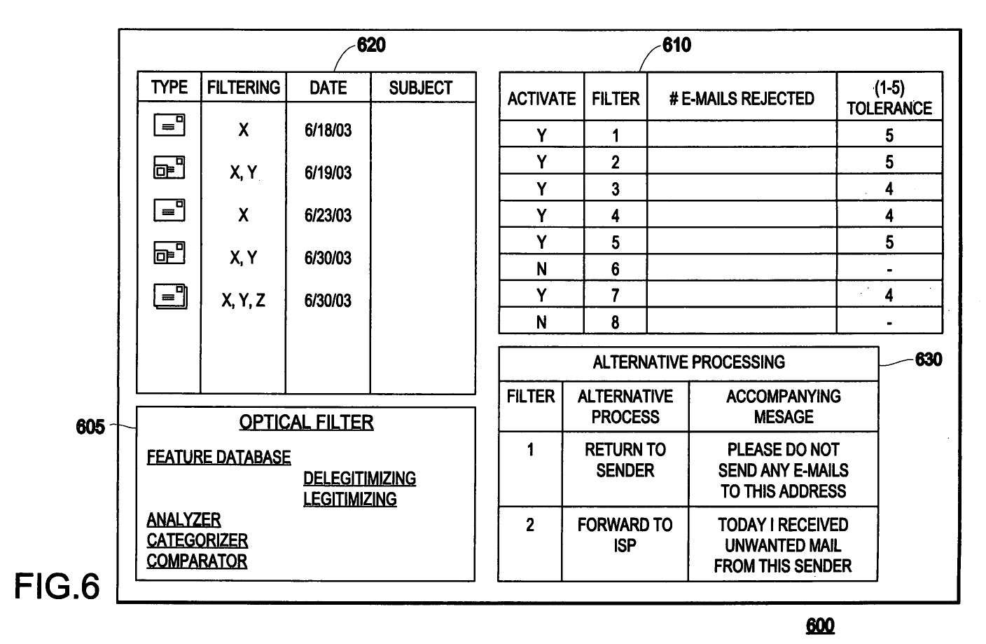

In another exemplary aspect of the present invention, a display screen 600 (e.g., illustrated in FIG. 6) may allow the user to easily monitor the performance of the inventive filter (e.g., in the inventive system) in addition to any other filters. For example, the display screen 600 may be included as a part of the e-mail message browsing software (e.g., a web browser) or as a part of filter control software (e.g., installed in the user terminal).

For example, the display screen 600 may include an area 605 for controlling and/or monitoring the operation of the inventive filter (e.g., filter 400). For example, clicking on “De-legitimizing Feature Database” may allow the user to view (in another screen) and/or manipulate the contents (e.g., images, features, feature weights, de-legitimizing degree, etc.) of the de-legitimizing feature database, and so forth. Further, the area 605 may be used to vary a characteristic (e.g., a tolerance) of an analyzer, categorizer, or comparator of the inventive filter.

For example, the display screen 600 may include an area 610 which includes a list of the filters 520 and indicates which are activated and which are deactivated, and the number of e-mails rejected (e.g., for a selectable period). This allows the user to easily activate and deactivate one or more of the filters 520 in the inventive system 500 by simply using his mouse to click on the corresponding “activate” box for a filter.

Further, area 610 may be used to allow the user to easily increase or decrease the tolerance of his filters using the browser. Thus, for example, if the user finds that his software is returning too many false positives, he may loosen the tolerance on one or more filters to eliminate the false positives.

In addition, the display screen 600 may include an area 620 which provides more detailed information about the e-mails which were rejected. The area 620 may include columns for identifying the type, date and subject of the e-mail. Further, the area 620 may include a list of the e-mails that have been filtered out using which type of filter (e.g., Filter X, Filter Y, etc.), and on which date. This is important for allowing the user to customize his filtering based on the types of e-mail he customarily receives. That is, some users may customarily receive e-mails from friends, co-employees, etc., which are more likely to be mistakenly filtered out using some filtering devices. The inventive display screen 600 allows the user to select to deactivate such a filter which mistakenly filters out desirable messages.

Likewise, certain filters may be especially effective at filtering out the type of “spam” which the user ordinarily would receive. Therefore, the claimed invention allows the user to select to activate such a filter.

The inventive display screen 600 may also include an area 630 which allows the user to control the alternative processing of e-mails that are rejected by the inventive system 500. The area 630 may include, for example, a list of the filters in the system, the alternative process for each filter, and any accompanying message which the sender would like to create to send along with the rejected e-mails being returned or forwarded.

For example, in area 630, the user may set the alternative process for rejected e-mail such that such e-mail is simply canceled and not forwarded to the intended receiver, or the e-mail may be returned to a sender with a failure message or even another message which may be pre-made or crafted by the user. Further, the present invention may allow the user to forward the rejected e-mail not back to the sender, but to a third party.

For example, the user may use area 630 to configure the system such that every time an e-mail message is rejected is rejected by the system, his Internet Service Provider (ISP) receives an e-mail message. This allows the system to automatically update the Internet service provider on e-mail messages that may be getting through certain filters before arriving at and being filtered by the inventive system.

In addition, an e-mail including at least one of a predetermined identification information and a predetermined amount of electronic postage may be approved (e.g., not rejected) by the inventive system.

Further, the present invention may be used to filter e-mail messages including an attachment. For example, an attached file may include an image (e.g., bitmap, JPEG, GIF, PDF, etc.), a word processing document, spreadsheet, or program.

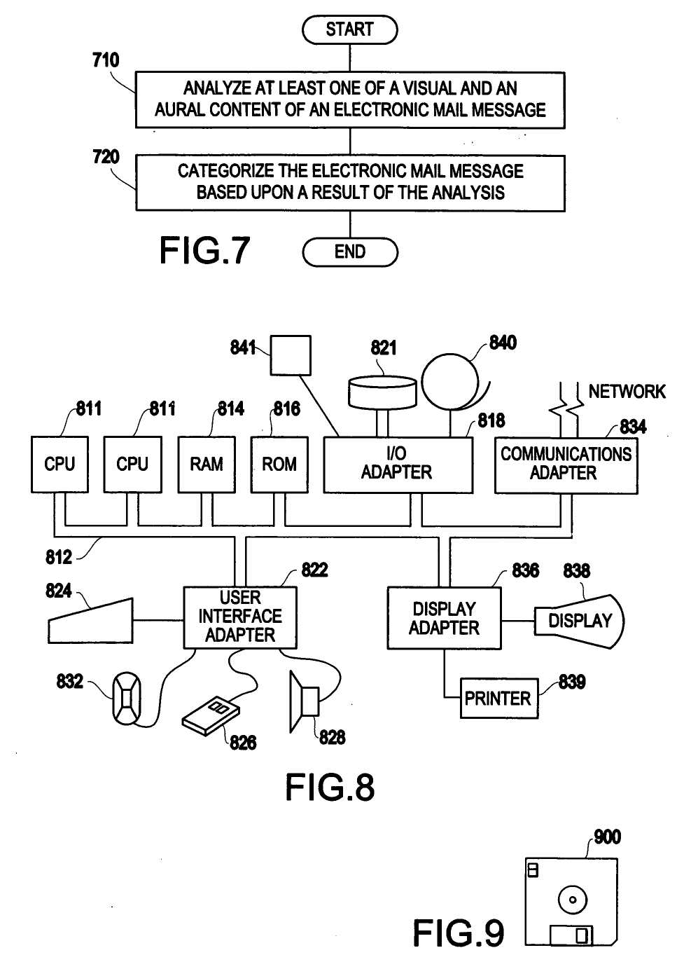

Another exemplary aspect of the present invention includes an inventive method 700 of filtering electronic mail messages. For example, as shown in FIG. 7, the inventive method 700 may include optically analyzing (710) a content of an electronic mail message, and categorizing (720) the electronic mail message based upon a result of the optical analysis.

Another exemplary aspect of the present invention includes an inventive method of filtering an electronic message. The method includes at least one of optically and aurally analyzing a content of the electronic message, and categorizing the electronic message based upon a result of the at least one of optically and aurally analyzing the content. For example, the operation of this exemplary embodiment may be similar to that discussed above with respect to image data and optical analysis (which is incorporated herein), except that in this embodiment, image data may be replaced with audio data, and the optical analysis may be replaced with an aural analysis.

For example, the claimed invention may include an optical/aural filter for filtering an electronic message. The filter may include, for example, an optical/aural recognition device which at least one of optically and aurally analyzes a content of the electronic message, and categorizes the electronic message based upon a result of the optical and/or aural analysis. For example, the optical/aural recognition device may include an audio feature database, so that audio features may be extracted from the electronic message (e.g., electronic mail message) and compared to the audio features (e.g., legitimizing and delegitimizing audio features) stored in the audio feature database, so that the electronic message may be categorized (e.g., as legitimate or not legitimate).

Referring now to FIG. 8, system 800 illustrates a typical hardware configuration which may be used for implementing the inventive system and method for filtering electronic mail messages. The configuration has preferably at least one processor or central processing unit (CPU) 811. The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, and Intranet, a personal area network (PAN), etc., and a display adapter 836 for connecting the bus 812 to a display device 838 and/or printer 839. Further, an automated reader/scanner 841 may be included. Such readers/scanners are commercially available from many sources.

In addition to the system described above, a different exemplary aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this exemplary aspect of the present invention is directed to a programmed product, including signal-bearing media tangibly embodying a program of machine-readable instructions executable by a digital data processor to perform the above method.

Such a method may be implemented, for example, by operating the CPU 811 to execute a sequence of machine-readable instructions. These instructions may reside in various types of signal bearing media.

Thus, this exemplary aspect of the present invention is directed to a programmed product, comprising signal-bearing media tangibly embodying a program of machine-readable instructions executable by a digital data processor incorporating the CPU 811 and hardware above, to perform the method of the invention.

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the computer server/CPU 811, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as C, C++, etc.

With its unique and novel features, the present invention provides a filter, system and method for filtering electronic mail messages which efficiently and effectively filters electronic mail messages (e.g., messages including images).

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

For example, it should be understood that the present invention may be practiced with equal efficiency and effectiveness on e-mail messages which include a video image (e.g., motion) file or data (e.g., an MPEG) file, as well as a still image file or data (e.g., JPEG, GIF, TIFF, bitmap, etc.).

Further, Applicant's intent is to encompass the equivalents of all claim elements, and no amendment to any claim the present application should be construed as a disclaimer of any interest in or right to an equivalent of any element or feature of the amended claim.

1. A filter for filtering an electronic mail message, comprising:
a recognition device which analyzes at least one of a visual and an aural content of said electronic mail message, and categorizes said electronic mail message based upon a result of the analysis.

2. The filter according to claim 1, wherein said recognition device comprises an aural recognition device.

3. The filter according to claim 1, wherein said recognition device comprises an optical recognition device.

4. The filter according to claim 3, wherein said content comprises an image, and said optical recognition device comprises an optical image recognition device which indexes, recognizes, and describes said image according to at least one visual feature in said image.

5. The filter according to claim 4, wherein said image comprises one of a photograph, design, and illustration.

6. The filter according to claim 4, wherein said optical recognition device analyzes said content by segmenting said image into a plurality of segments.

7. The filter according to claim 3, wherein said content comprises a content of an attachment to said electronic mail message.

8. The filter according to claim 3, wherein said optical recognition device assigns an identifier to at least one segment in said plurality of segments.

9. The filter according to claim 8, wherein said identifier comprises at least one of a color, texture, shape, spatial configuration, image quality, image size, image brightness, contrast, distortion, object translation, object rotation and scale, and any combination thereof.

10. The filter according to claim 9, further comprising:
at least one feature database, said optical recognition device comparing said identifier with data in said feature database.

11. The filter according to claim 10, wherein features stored in said feature database are weighted according to at least one of a legitimizing degree and de-legitimizing degree, and wherein said features are compared with said identifiers in the order of said one of said legitimizing degree and de-legitimizing degree.

12. The filter according to claim 10, wherein said data comprises de-legitimizing features comprising at least one of a de-legitimizing word, de-legitimizing image, de-legitimizing grammar, de-legitimizing alphanumeric character, and de-legitimizing punctuation mark.

13. The filter according to claim 10, wherein said data comprises legitimizing features comprising at least one of a legitimizing word, legitimizing image, legitimizing grammar, legitimizing alphanumeric character, and legitimizing punctuation mark.

14. The filter according to claim 3, wherein said optical recognition device categorizes said electronic mail message into one of at least two categories, said at least two categories comprising legitimate and illegitimate.

15. The filter according to claim 3, wherein said optical recognition device comprises at least one of an optical character recognition device and an optical image recognition device.

16. The filter according to claim 3, wherein said optical recognition device comprises a display screen which displays said content.

17. The filter according to claim 3, wherein said optical recognition device analyzes said content and categorizes said electronic mail message in substantially real time.

18. The filter according to claim 3, wherein said optical recognition device comprises a trainable optical recognition device.

19. The filter according to claim 3, wherein said optical recognition device analyzes said content according to a predetermined optical recognition algorithm.

20. A system for filtering an electronic mail message, comprising:
a network comprising a plurality of user terminals; and
at least one filter for filtering an electronic mail message sent between terminals in said plurality of terminals, said at least one filter comprising:
a recognition device which analyzes at least one of a visual and an aural content of said electronic mail message, and categorizes said electronic mail message based upon an analysis.

21. The system according to claim 20, wherein said recognition device comprises an optical recognition device.

22. The system according to claim 21, further comprising:
an alternative processing device which routes said electronic mail message which has been categorized,
wherein if said electronic mail message is categorized as legitimate, said system forwards said electronic mail message to an intended receiver of said electronic mail message

23. The system according to claim 22, wherein if said electronic mail message is categorized as illegitimate, said alternative processing device routes said electronic mail message back to a sender of said electronic mail message.

24. The system according to claim 22, wherein said at least one filter comprises a plurality of filters comprising at least one centrally-located filter and at least one distributed filter.

25. A method of filtering an electronic mail message, comprising:
analyzing at least one of an optical and an aural content of said electronic mail message; and
categorizing said electronic mail message based upon a result of said analyzing said content.

26. A programmable storage medium tangibly embodying a program of machine-readable instructions executable by a digital processing apparatus to perform a method of filtering an electronic mail message, said method comprising:
analyzing at least one of an optical and an aural content of said electronic mail message; and
categorizing said electronic mail message based upon a result of said analyzing said content.
